(19) United States
(12) Patent Application Publication
(10) Pub. No.: US 2013/0096297 A1
(43) Pub. Date: Apr. 18, 2013

(54) Methods for Synthesizing Acylated Cellulose Through Instillation of an Acidic Catalyst

(71) Applicants: Michael T. Combs, Shady Spring, WV (US); Thomas S. Garrett, Narrows, VA (US)

(72) Inventors: Michael T. Combs, Shady Spring, WV (US); Thomas S. Garrett, Narrows, VA (US)

(73) Assignee: Celanese Acetate LLC, Dallas, TX (US)

(21) Appl. No.: 13/273,304

(22) Filed: Oct. 14, 2011

(51) Int. Cl. C08B 3/24; C08B 3/06

(52) U.S. Cl. 536/76; 536/69

(57) ABSTRACT

Instilling an acidic catalyst to a reaction mixture can be beneficial during the acylation of cellulose. Methods described herein can comprise preparing a reaction mixture comprising an acylating agent and cellulose, instilling a catalyst comprising an acid to the reaction mixture at an overall catalyst loading level of about 1% or less by weight of the cellulose, and reacting the cellulose with the acylating agent in the presence of the catalyst, thereby forming an acylated cellulose.

### BACKGROUND

The present invention generally relates to methods for performing acylation reactions by instillation of an acidic catalyst to a reaction mixture, and, more specifically, to acylated polymers, particularly acetylated cellulose, prepared by said methods.

Cellulose is a naturally occurring biopolymer comprising β-D-glucose monomer units. Cellulose is commonly obtained from wood pulp sources for use in commercial applications. Naturally occurring cellulose is a hydrophilic material that is substantially insoluble in water and most organic solvents. However, the three free hydroxyl groups of each glucose monomer unit in cellulose can be derivatized, if desired, to modify its properties. Most typically, acylation of cellulose is conducted using acidic catalysts at elevated reaction temperatures in order to modify its properties.

One particular cellulose derivative that has been commonly used in commercial products is acetylated cellulose, also commonly referred to as cellulose acetate, where the degree of acetyl substitution is unspecified. Unless otherwise set forth herein, it is to be understood that the terms “acetylated cellulose” or “cellulose acetate” will refer to a derivatized cellulose having any specified degree of acetyl substitution. Exhaustively acetylated cellulose is commonly referred to as cellulose triacetate, where, according to Federal Trade Commission guidelines, at least 92% of the hydroxyl groups are substituted with acetyl groups. At higher degrees of acetyl substitution, the rate of biodegradation can be significantly reduced relative to naturally occurring cellulose or cellulose having less acetyl substitution. For example, when there are at least about two acetyl groups per cellulose monomer unit (that is, a degree of substitution (“DS”) of about 2 or an acetylation value (“AV”) of about 48), the acetylated cellulose can become significantly less biodegradable until at least some of the acetyl groups are removed via chemical or enzymatic hydrolysis. Acetylated cellulose having reduced DS values can be prepared by controlled partial hydrolysis of cellulose triacetate.

Typically, acetylated cellulose is prepared by reacting cellulose with an acetylating agent in the presence of a suitable acidic catalyst. In most cases, the cellulose is exhaustively acetylated with the acetylating agent to produce a derivatized cellulose having a high DS value along with some additional hydroxyl group substitution (e.g., sulfate esters) in some cases. As used herein, the term “exhaustively acetylated” will refer to an acetylation reaction that is driven toward completion such that as many hydroxyl groups as possible in cellulose undergo an acetylation reaction. As currently performed, exhaustive acetylation of cellulose can take upwards of 4 hours or more to reach completion. These extended reaction times can add considerably to the cost of an industrial scale synthesis. For example, at the industrial scale, each additional minute of process time can add thousands to millions of dollars to the cost of a process batch, ultimately leading to increased costs for the consumer. Furthermore, prolonged exposure to the acidic conditions at high temperatures can contribute to partial hydrolysis (shortening) of the cellulose polymer backbone in some cases. Most often, some of the acetyl groups of exhaustively acetylated cellulose are subsequently removed by controlled partial hydrolysis to produce an acetylated cellulose having a desired set of properties (e.g., an acetylated cellulose with a DS of about 2 to about 2.5, which is known as cellulose diacetate or secondary acetate).

Suitable acidic catalysts for promoting the acetylation of cellulose often contain sulfuric acid or a mixture of sulfuric acid and at least one other acid. Other acidic catalysts not containing sulfuric acid can similarly be used to promote the acetylation reaction. In the case of sulfuric acid, at least some of the hydroxyl groups in the cellulose can become initially functionalized as sulfate esters during the acetylation reaction. Typically, most of these sulfate esters are cleaved during the controlled partial hydrolysis used to reduce the amount of acetyl substitution. Other acidic catalysts typically are much less likely to themselves react with the hydroxyl groups of cellulose.

One of the more highly desirable attributes of acetylated cellulose is that it can be readily processed into several different forms including, for example, films, flakes, fibers (e.g., fiber tows), non-deformable solids and the like depending on its intended end use application. Most often, the acetylated cellulose obtained from controlled partial hydrolysis precipitates as a flake material. Acetylated cellulose flakes can thereafter be subjected to further processing in order to convert the acetylated cellulose into a desired form. For example, acetylated cellulose filaments can be formed by dry spinning an acetone dope through a spinneret, which can then be bundled and crimped together in tow form.

Acetylated cellulose can be used to make a variety of consumer products including, for example, textiles, adhesives, plastic films, paints, absorbent materials, cigarette filters and the like. The biodegradability of acetylated cellulose can be particularly useful from a waste disposal standpoint when it is used in these types of consumer products and others.

### SUMMARY

The present invention generally relates to methods for performing acylation reactions by instillation of an acidic catalyst to a reaction mixture, and, more specifically, to acylated polymers, particularly acetylated cellulose, prepared by said methods.

In one embodiment, the present invention provides a method comprising: preparing a reaction mixture comprising an acylating agent and cellulose; instilling a catalyst comprising an acid to the reaction mixture; and reacting the cellulose with the acylating agent in the presence of the catalyst, thereby forming an acylated cellulose.

In one embodiment, the present invention provides a method comprising: preparing a reaction mixture comprising acetic anhydride, cellulose and a first portion of a catalyst comprising at least sulfuric acid; instilling at least a second portion of the catalyst to the reaction mixture; and reacting the cellulose with the acetic anhydride in the presence of the catalyst, thereby forming an acetylated cellulose.

In one embodiment, the present invention provides a method comprising: preparing a reaction mixture comprising acetic anhydride and cellulose; instilling a catalyst comprising at least sulfuric acid to the reaction mixture, thereby forming a reaction product that comprises an acetylated cellulose; and hydrolyzing a portion of the acetyl groups on the acetylated cellulose to produce an acetylated cellulose having a degree of substitution (DS) of about 2.5 or lower.

In one embodiment, the present invention provides a method comprising: preparing a reaction mixture comprising an acylating agent and cellulose; instilling a catalyst comprising an acid to the reaction mixture at an overall catalyst loading level of about 1% or less by weight of the cellulose; and reacting the cellulose with the acylating agent in the presence of the catalyst, thereby forming an acylated cellulose.

In one embodiment, the present invention provides a method comprising: preparing a reaction mixture comprising acetic anhydride, cellulose and a first portion of a catalyst comprising at least sulfuric acid; instilling at least a second portion of the catalyst to the reaction mixture at an overall catalyst loading level of about 1% or less by weight of the cellulose; and reacting the cellulose with the acetic anhydride in the presence of the catalyst, thereby forming an acetylated cellulose.

In one embodiment, the present invention provides a method comprising: preparing a reaction mixture comprising acetic anhydride and cellulose; instilling a catalyst comprising at least sulfuric acid to the reaction mixture at an overall catalyst loading level of about 1% or less by weight of the cellulose, thereby forming a reaction product that comprises an acetylated cellulose; and hydrolyzing a portion of the acetyl groups on the acetylated cellulose to produce an acetylated cellulose having a degree of substitution (DS) of about 2.5 or lower.

In one embodiment, the present invention provides a method comprising: preparing a reaction mixture comprising an acylating agent and cellulose; instilling a catalyst comprising an acid to the reaction mixture at an overall catalyst loading level of about 10% to about 20% by weight of the cellulose; and reacting the cellulose with the acylating agent in the presence of the catalyst, thereby forming an acylated cellulose.

In one embodiment, the present invention provides a method comprising: preparing a reaction mixture comprising acetic anhydride, cellulose and a first portion of a catalyst comprising at least sulfuric acid; instilling at least a second portion of the catalyst to the reaction mixture at an overall catalyst loading level of about 10% to about 20% by weight of the cellulose; and reacting the cellulose with the acetic anhydride in the presence of the catalyst, thereby forming an acetylated cellulose.

In one embodiment, the present invention provides a method comprising: preparing a reaction mixture comprising acetic anhydride and cellulose; instilling a catalyst comprising at least sulfuric acid to the reaction mixture at an overall catalyst loading level of about 10% to about 20% by weight of the cellulose, thereby forming a reaction product that comprises an acetylated cellulose; and hydrolyzing a portion of the acetyl groups on the acetylated cellulose to produce an acetylated cellulose having a degree of substitution (DS) of about 2.5 or lower.

The features and advantages of the present invention will be readily apparent to one having ordinary skill in the art upon a reading of the description of the preferred embodiments that follows.

### DETAILED DESCRIPTION

The present invention generally relates to methods for performing acylation reactions by instillation of an acidic catalyst to a reaction mixture, and, more specifically, to acylated polymers, particularly acetylated cellulose, prepared by said methods.

Although conventional commercial syntheses of acylated cellulose, particularly acetylated cellulose, are most often conducted in the presence of an acidic catalyst, the way that these acidic catalysts are presently used can result in several inherent process disadvantages. Conventional acylation processes can utilize a single addition of relatively high acid concentrations, particularly sulfuric acid, and peak reaction temperatures in excess of 100° C. in order to maintain reaction rates that are compatible with commercial production processes. Even under these conditions, long reaction times can be needed to achieve exhaustive acylation of cellulose, thereby adding significantly to process costs. Furthermore, under prolonged exposure to these conditions, the cellulose polymer backbone can become partially hydrolyzed by excess acid, thereby shortening the polymer chain through glycosidic hydrolysis and altering the mechanical properties of the polymer. In addition, the relatively high concentrations of acid, including that incorporated in the acylated cellulose, can necessitate considerable workup of the reaction's mother liquor so that disposal can take place in accordance with environmental regulations.

Without being bound by any theory or mechanism, it is believed that when sulfuric acid is used to catalyze the acylation of cellulose, at least some of the sulfuric acid can react with the acylating agent (e.g., acetic anhydride) to produce an acylsulfuric acid derivative (e.g., acetosulfuric acid), which can either persist or react with cellulose to form a sulfate ester of cellulose. In either event, the sulfuric acid is no longer available to catalyze the acylation process, and the reaction can eventually slow as a result. The use of high acid concentrations and extended reaction times in conventional cellulose acylation processes can be used to at least partially address the consumption of the catalyst.

It has been surprisingly discovered according to the present embodiments that if the acidic catalyst is instilled into the reaction mixture, instead of being added all at once, an acylated cellulose can be prepared that is at least comparable in properties to conventionally synthesized acylated cellulose by using lower acid concentrations and shorter reaction times. However, it should be noted that acidic catalyst levels that are substantially the same as those conventionally used in the art can also be used in the present embodiments to achieve comparable results. Reaction temperatures comparable to those conventionally used in the art can be used if glycosidic hydrolysis is not a particular concern. Lower acid concentrations and shorter reaction times can significantly benefit commercial synthesis processes, particularly to lower their cost. Furthermore, the properties of the acylated cellulose synthesized using an instilled catalyst can sometimes be different than those obtained when a single addition of catalyst is used. As used herein, the term “instill” and grammatical equivalents thereof will be used to denote an addition process in which less than all of a material is added to a reaction mixture at a single time. In various embodiments, instilling can involve a portionwise addition to the reaction mixture. In other various embodiments, instilling can involve a continuous addition to the reaction mixture. Again without being bound by theory or mechanism, it is believed that by instilling an acidic catalyst (e.g., sulfuric acid) into an acylation reaction mixture, the formation of acylsulfuric acid derivatives can be minimized, such that fresh sulfuric acid is more readily available for catalysis. Although acylsulfuric acid derivatives can rapidly acylate cellulose, it is believed that the rapid formation of acylsulfuric acid derivatives in conventional syntheses can result in catalyst consumption, eventually lowering the reaction rate. According to the present embodiments, as the reaction rate begins to slow, fresh acidic catalyst can be instilled, such that the rate of acylsulfuric acid formation is leveled and the overall reaction rate remains high, even at low levels of acidic catalyst loading.

As used herein, the term “acylating agent” refers to a compound that donates an acyl group electrophile to a nucleophile.

As used herein, the term “degree of substitution (DS)” refers to the average number of acetyl units per cellulose monomer unit.

As used herein, the term “acetyl value (AV)” refers to the average weight percent of acetyl substitution in acetylated cellulose, measured as acetic acid.

As used herein, the term “overall catalyst loading level” refers to the total percentage by weight of catalyst added to a reaction mixture, as measured relative to the amount of cellulose. The overall catalyst loading level includes any quantity of catalyst added initially to the reaction mixture prior to instilling any remaining amount of catalyst.

In some embodiments, methods described herein can comprise: preparing a reaction mixture comprising an acylating agent and cellulose, instilling a catalyst comprising an acid (e.g., sulfuric acid and, optionally, phosphoric acid) to the reaction mixture, and reacting the cellulose with the acylating agent in the presence of the catalyst, thereby forming an acylated cellulose. In some of the embodiments that follow, the acylated cellulose can be an acetylated cellulose (i.e., cellulose acetate), prepared using acetic anhydride as an acetylating agent. However, any embodiment in which cellulose acetate is specifically described can be practiced in a like manner through use of an acylating agent other than acetic anhydride. When acylating agents other than acetic anhydride are used, the acyl group electrophile will be used to denote the functionalized cellulose formed. For example, when propionic anhydride is used as the acylating agent, the functionalized cellulose can be referred to as cellulose propionate.

Acylating agents suitable for use in the present embodiments can include both carboxylic acid anhydrides (or simply anhydrides) and carboxylic acid halides, particularly carboxylic acid chlorides (or simply acid chlorides). Suitable acid chlorides can include, for example, acetyl chloride, propionyl chloride, butyryl chloride, benzoyl chloride and like acid chlorides. Suitable anhydrides can include, for example, acetic anhydride, propionic anhydride, butyric anhydride, benzoic anhydride and like anhydrides. Mixtures of these anhydrides or other acylating agents can also be used in order to introduce differing acyl groups to the cellulose. Mixed anhydrides such as, for example, acetic propionic anhydride, acetic butyric anhydride and the like can also be used for this purpose in some embodiments.

In some embodiments, the catalyst can be diluted while being instilled to the reaction mixture. Generally, it can be advantageous to dilute the catalyst during instillation so as to make its volumetric addition more facile. Specifically, it can be difficult to accurately instill small volumes of neat (concentrated) acid, particularly neat sulfuric acid. Furthermore, neat sulfuric acid is somewhat viscous, which can further complicate its instillation to a reaction mixture. Similar issues can be encountered with other neat acids. Typically, the catalyst can be diluted in a solvent or reactant that is already present in the reaction mixture such as, for example, acetic acid and/or acetic anhydride, or a like carboxylic acid and/or anhydride. Other solvents that are substantially inert to the reaction conditions such as, for example, hydrocarbons, ethers and halogenated solvents can optionally be used as well in some embodiments. It should be recognized that use of a diluent is optional, and in some embodiments, the catalyst can be added neat to the reaction mixture.

Instillation of the catalyst to the reaction mixture can take place in any manner such that less than all the catalyst is added to the reaction mixture at a single time. In some embodiments, the catalyst can be instilled portionwise to the reaction mixture while reacting to form the acylated cellulose takes place. In other embodiments, the catalyst can be instilled continuously to the reaction mixture while reacting to form the acylated cellulose takes place.

Portionwise instillation can be conducted such that the catalyst is instilled discontinuously to the reaction mixture. The number of portions instilled to the reaction mixture can generally vary without limitation. In some embodiments, two portions of the catalyst can be instilled to the reaction mixture. In other embodiments, three portions of the catalyst, or four portions of the catalyst, or five portions of the catalyst, or six portions of the catalyst, or seven portions of the catalyst, or eight portions of the catalyst, or nine portions of the catalyst, or ten portions of the catalyst can be instilled to the reaction mixture. More portions of the catalyst can be instilled to the reaction mixture if dictated by operational needs. Generally, portionwise instillation of the catalyst can take place over a time period ranging from about 3 minutes to about 120 minutes in some embodiments, or between about 3 minutes and about 30 minutes in other embodiments.

In some embodiments, all of the portions of catalyst instilled to the reaction mixture can be of substantially the same size. In other embodiments, at least some of the portions of catalyst can be of different sizes. For example, in some embodiments, it may be desirable to use larger or smaller portions of catalyst during the early course of the reaction so as to control (increase or decrease) the reaction rate, and once the reaction has become stabilized to use a different catalyst portion size during the later course of the reaction.

In some embodiments, portionwise instillation can be conducted such that the time spacing between instillation of each portion is substantially the same. In other embodiments, the time spacing between instillation of each portion can be different. For example, in some embodiments, instillation of each portion can be conducted each time the peak reaction temperature, which is related to the reaction rate, drops below a predetermined level. Other reaction parameters, including spectroscopic evaluation, can be used to trigger instillation of a fresh catalyst portion in other embodiments. According to the present embodiments, the instillation of fresh catalyst portions can be used to maintain the reaction rate at a desirable high level. In some embodiments, the rate for portionwise instillation can be chosen such that the peak reaction temperature remains at about 105° C. or less. In other embodiments, the rate for portionwise instillation can be chosen such that the peak reaction temperature remains at about 75° C. or less.

Continuous instillation of the catalyst can take place through any mechanism known to one having ordinary skill in the art. In some embodiments, the catalyst can be instilled dropwise to the reaction mixture. In other embodiments, the catalyst can be instilled as a continuous stream to the reaction mixture. Suitable mechanisms for continuous instillation of the catalyst can include, for example, metered flow addition, syringe pump addition, dropping funnels, and the like.

Suitable rates for continuous instillation of the catalyst can vary over a considerable range. In some embodiments, the rate for continuous instillation can be chosen such that the peak reaction temperature remains at about 105° C. or less. In other embodiments, the rate for continuous instillation can be chosen such that the peak reaction temperature remains at about 75° C. or less. In some embodiments, the rate for continuous instillation can be such that the catalyst is instilled to the reaction mixture over a time period ranging between about 3 minutes and about 120 minutes. In other embodiments, the rate for continuous instillation can be such that the catalyst is instilled to the reaction mixture over a time period ranging between about 5 minutes and about 30 minutes.

In some embodiments, the catalyst can be continuously instilled to the reaction mixture over less than the whole time that reacting takes place. That is, in such embodiments, the catalyst can be continuously instilled over a period of time and once catalyst instillation is complete, the reaction can be allowed to progress further for an additional period of time. Optionally, continuous instillation of the catalyst can be continued after the additional period of time passes. In some embodiments, the catalyst can be continuously instilled to the reaction mixture over the whole time that reacting takes place. That is, in such embodiments, the catalyst can be continuously instilled over a period of time, and once catalyst instillation is complete, the reaction can be worked up very soon thereafter to isolate and purify the acylated cellulose product.

In some embodiments, a combination of continuous instillation and portionwise instillation of the catalyst can be used. For example, in some embodiments, continuous instillation of the catalyst can take place early in the course of the reaction, and once continuous instillation is complete, portionwise instillation of the catalyst can take place thereafter to maintain a desired reaction rate. In other embodiments, one or more portionwise instillations of the catalyst can take place early in the course of the reaction, with the remaining catalyst being instilled continuously thereafter. Other combinations of continuous and portionwise instillation can be envisioned by one having ordinary skill in the art.

In further variations of the present methods, any one of the reactants or solvents used in the reaction can also be instilled to the reaction mixture at the same time or separately from the instillation of catalyst. For example, any one of the acylating agent (e.g., acetic anhydride) or the reaction solvent (e.g., acetic acid) can also be instilled to the reaction mixture.

In some embodiments, the reaction mixture can comprise a first portion of the catalyst, and at least a second portion of the catalyst can be instilled to the reaction mixture thereafter. In such embodiments, the first portion of the catalyst in the reaction mixture can help initiate the acylation reaction, and the second portion of the catalyst can maintain the reaction at a desirably high rate thereafter. In some embodiments, the second portion of catalyst can be instilled in multiple portions (i.e., portionwise) to the reaction mixture. In some or other embodiments, the second portion of catalyst can be instilled continuously to the reaction mixture.

In general, the reaction between the acylating agent and the cellulose is accompanied by a rise in temperature as an exothermic reaction between the two takes place. In some embodiments, the instillation rate of the catalyst can be adjusted to maintain the peak reaction temperature in a desired range. In some embodiments, active cooling of the reaction mixture can also be used to maintain the peak reaction temperature in the desired range. Active cooling techniques for the reaction mixture will be familiar to one having ordinary skill in the art and can include, for example, exposure to a cooling bath (e.g., an ice bath or a cryogenic fluid bath), cooling water or a like heat exchange fluid, air cooling, and the like. In some embodiments, reacting can take place at a temperature of about 105° C. or less. In other embodiments, reacting can take place at a temperature of about 70° C. or less. As noted previously, an advantage of the present methods is the ability to maintain the peak reaction temperature at low levels, which can sometimes provide an acylated cellulose having different properties than conventionally obtained in the art.

In addition, the reaction times needed to exhaustively acylate cellulose using the presently described methods can be significantly shorter than those conventionally employed in the art. For example, in some embodiments, the reaction time required to exhaustively acylate cellulose can be about 1 hour or less. As previously described, such short reaction times can considerably lower production costs.

In general, the exothermic reaction between the acylating agent and the cellulose produces a maximum exotherm (i.e., a maximum temperature) at some point after the catalyst has been added. In some embodiments, at least a portion of the catalyst can be instilled to the reaction mixture after the maximum exotherm of the reaction has been reached. In embodiments in which the catalyst is instilled portionwise to the reaction mixture, each instillation can produce local temperature maxima that is less than the maximum exotherm. By instilling at least a portion of the catalyst after the maximum exotherm (i.e., peak reaction temperature) is reached and the reaction temperature is falling, the reaction rate can be maintained at a desirably high level during the latter course of the reaction. Furthermore, improved solution clarity and filterability of the acylated cellulose can be realized in some cases.

When at least a portion of the catalyst is instilled after reaching the maximum exotherm, an amount of the catalyst instilled after the maximum exotherm can be up to about 50% of the overall catalyst loading level in some embodiments or up to about 10% of the overall catalyst loading level in other embodiments. In other various embodiments, the amount of catalyst instilled after reaching the maximum exotherm can be up to about 5%, or up to about 2%, or up to about 1% of the overall catalyst loading level. In some embodiments, the amount of catalyst instilled after reaching the maximum exotherm can range between about 1% and about 2% of the overall catalyst loading level.

By instilling the catalyst to the reaction mixture according to the present embodiments, low overall catalyst loading levels can be used to achieve a desired rate of reaction. In some embodiments, an amount of the catalyst can range between about 0.5% to about 15% by weight of the cellulose. In some embodiments, an amount of the catalyst can range between about 0.5% and about 8% by weight of the cellulose. In some embodiments, an amount of the catalyst can range between about 0.5% and about 1.5% by weight of the cellulose. In some embodiments, an amount of the catalyst can range up to about 0.6% by weight of the cellulose. In some embodiments, an amount of the catalyst can range up to about 0.75% by weight of the cellulose. In some embodiments, an amount of the catalyst can range up to about 1% by weight of the cellulose. In some embodiments, an amount of the catalyst can range between about 10% and about 20% by weight of the cellulose. In some embodiments, an amount of the catalyst can range between about 10% and about 15% by weight of the cellulose. In some embodiments, an amount of the catalyst can range between about 10% and about 12% by weight of the cellulose. In some embodiments, an amount of the catalyst can range between about 12% and about 15% by weight of the cellulose. In some embodiments, an amount of the catalyst can range between about 5% and about 10% by weight of the cellulose. In some embodiments, an amount of the catalyst can range between about 7% and about 8% by weight of the cellulose. The foregoing catalyst weight percentages refer to the overall catalyst loading level of the reaction mixture.

Use of low levels of instilled catalyst, particularly below about 1% by weight of the cellulose, can be advantageous by maintaining or improving upon reaction rates typically seen in the art where catalyst instillation is not used. The improved reaction rates can be particularly beneficial for commercial production processes, where shorter reaction times or lower operating temperatures can directly translate into significantly reduced operational costs. Furthermore, use of lower catalyst levels can result in less hazardous operating conditions during commercial production processes. In addition, the acylated cellulose can sometimes have different properties than those obtained when catalyst instillation is not used.

In some embodiments, the catalyst levels can be higher so as to be comparable to those typically employed in the art, but where catalyst instillation is not used (e.g., about 10% to about 15% by weight of the cellulose). Product and process advantages can similarly be realized when catalyst instillation is used at these higher catalyst levels. A particular advantage of these higher catalyst levels is that they are compatible with existing ripening processes in which cellulose acetate is partially hydrolyzed to remove some of its acetyl groups (e.g., to produce cellulose diacetate). As described below, the acid catalyst can be partially neutralized prior to ripening, and the residual acid can be used to carry out the partial acetyl hydrolysis. Thus, the present methods can be advantageously carried out with existing process equipment for producing cellulose diacetate, particularly when using higher concentrations of acid. However, reduced reaction times can also be used according to some of the present embodiments.

In various embodiments, the catalyst can comprise at least sulfuric acid. In some embodiments, the catalyst can further comprise at least one other acid. Other suitable acids that can be used in combination with or as a replacement for sulfuric acid can include, for example, hydrochloric acid, hydrobromic acid, hydroiodic acid, perchloric acid, phosphoric acid, trifluoromethanesulfonic acid, methanesulfonic acid, benzenesulfonic acid, toluenesulfonic acid, and the like. In some embodiments, the catalyst can further comprise phosphoric acid. When another acid is used in combination with sulfuric acid, the sulfuric acid content can vary over a wide range. In various embodiments, the sulfuric acid content of the catalyst can range between about 1% and about 100% by volume. In some embodiments, the sulfuric acid content can range between about 5% and about 50% by volume, and, in other embodiments, the sulfuric acid content can range between about 50% and about 95% by volume.

Generally, any cellulose source can be used in the present embodiments, from high quality dissolving grade celluloses (e.g., acetate grade pulp, dissolving grade pulp, viscose grade pulp and the like) to low quality non-dissolving grade celluloses (e.g., mechanical pulp, paper grade pulp, rag pulp, recycled fiber pulp, and the like). In general, high quality, dissolving grade celluloses will have an a-cellulose content of about 94% or greater, and low quality, non-dissolving grade celluloses will have an a-cellulose content below this value. It is to be recognized that depending on the intended application of the acylated cellulose, certain cellulose sources can be more advantageous than others in producing desired physical, chemical and mechanical properties of the acylated cellulose. Further, the ability to use low quality cellulose sources in the present embodiments makes the methods described herein particularly advantageous from an economic standpoint.

In some embodiments, methods described herein can comprise: preparing a reaction mixture comprising acetic anhydride, cellulose and a first portion of a catalyst comprising at least sulfuric acid; instilling at least a second portion of the catalyst to the reaction mixture; and reacting the cellulose with the acetic anhydride in the presence of the catalyst, thereby forming an acetylated cellulose (cellulose acetate).

When forming cellulose acetate according to the present embodiments, the time required to exhaustively acetylate the cellulose can be dependent upon the reaction rate. As previously described, the reaction rate can be maintained at a desirably high level by instilling the catalyst to the reaction mixture according to the present embodiments. Further, the reaction rate can be dependent upon the peak reaction temperature. In some embodiments, reacting to form cellulose acetate can take place at a peak reaction temperature of about 105° C. or less. In other embodiments, reacting to form cellulose acetate can take place at a peak reaction temperature of about 75° C. or less. In some embodiments, a time required to exhaustively acetylate the cellulose can be measured by determining the degree of substitution (DS) of the cellulose acetate. Measurement of the DS will be familiar to one having ordinary skill in the art. As used herein, a cellulose will be considered to be exhaustively acetylated when its DS value ranges between about 2.5 to about 3, that is, when there are between about 2.5 to about 3 acetyl groups per cellulose monomer unit. In some embodiments, a time required to reach a DS value between about 2.5 to about 3 can be at most about 1 hour. In other embodiments, a time required to reach a DS value between about 2.5 to about 3 can be at most about 50 minutes, or about 45 minutes, or about 40 minutes, or about 35 minutes, or about 30 minutes, or about 25 minutes, or about 20 minutes, or about 15 minutes in various embodiments. It is to be recognized that the time required to exhaustively acetylate the cellulose can be longer or shorter than these reaction times, and any desired length of reaction time can be used in the present embodiments. For example, in some embodiments, exposure to the reaction conditions can be continued even though acetylation is complete in order to achieve partial hydrolysis of the cellulose backbone, if desired.

In some embodiments, once an exhaustively acetylated cellulose acetate has been produced, the cellulose acetate can be further processed to selectively remove at least a portion of the acetyl groups and sulfate ester groups, if present. In some embodiments, the cellulose acetate can be hydrolyzed to remove a portion of the acetyl groups therefrom. Suitable techniques for hydrolyzing the acetyl groups of cellulose acetate can include, but are not limited to, those described in U.S. Pat. Nos. 3,767,642; 4,314,056; 4,439,605; and 5,451,672, each of which is incorporated herein by reference in its entirety. As one of ordinary skill in the art will recognize, at least a portion of the acid catalyst can be neutralized prior to partial hydrolysis taking place, particularly if higher acid catalyst concentrations are used. If lower acid catalyst concentrations are used, the partial hydrolysis can be conducted without further neutralization in some embodiments.

In some embodiments, the partial hydrolysis of the acetyl groups (also commonly referred to as ripening of the cellulose acetate) can take place at a temperature below the normal boiling point of acetic acid (b.p.≈117° C.). Higher catalyst loading levels are particularly compatible with such ripening temperatures, although lower catalyst loading levels can be used as well, if desired. In other embodiments, the partial hydrolysis of the acetyl groups can take place at a temperature at or above the normal boiling point of acetic acid (b.p.≠117° C.). Such ripening temperatures are particularly compatible with lower catalyst loading levels (e.g., <1% catalyst), although higher catalyst loading levels can be used as well, if desired. In some embodiments, pressure can be applied during the partial hydrolysis reaction in order to raise the normal boiling point of acetic acid and hence the hydrolysis reaction temperature. In some embodiments, the hydrolysis of the acetyl groups can also remove at least a portion of any residual sulfate groups from the cellulose acetate. In some embodiments, a cellulose acetate having a DS value or about 2.5 or less (AV of about 55.4 or less) can be produced after performing the hydrolysis.

In some embodiments, methods described herein can comprise: preparing a reaction mixture comprising acetic anhydride and cellulose; instilling a catalyst comprising at least sulfuric acid to the reaction mixture, thereby forming a reaction product that comprises an acetylated cellulose; and hydrolyzing at least a portion of the acetyl groups on the acetylated cellulose to produce an acetylated cellulose having a DS of about 2.5 or lower. In some embodiments, the methods can further comprise neutralizing at least a portion of the sulfuric acid prior to hydrolyzing.

Cellulose acetate synthesized according to the present embodiments can sometimes have different properties than those of a cellulose acetate prepared similarly, but without instilling the catalyst into the reaction mixture. Without limitation, properties that the cellulose acetate can sometimes exhibit when prepared according to the present embodiments include, for example, a different molecular weight, and an improved filterability (less insoluble material) compared to a cellulose acetate prepared in a like manner but without instilling the catalyst into the reaction mixture. In cases where the molecular weight is higher, the acetylated cellulose can demonstrate properties including, for example, improved mechanical strength and higher viscosity in solution. In cases where the cellulose acetate contains less insoluble material, the cellulose acetate product can maintain higher clarity in solution.

Cellulose acetate synthesized in accordance with the present methods can be used in any downstream application in which cellulose acetate is currently utilized. As noted previously, cellulose acetate synthesized in accordance with the present methods can sometimes have different physical, chemical or mechanical properties compared to conventionally produced cellulose acetate, which can favorably impact its performance in these downstream applications.

In some embodiments, cellulose acetate prepared in accordance with the present methods can be used in absorbent articles. Illustrative but non-limiting absorbent articles in which the cellulose acetate can be used include, for example, diapers, incontinence products, feminine hygiene products, bandages, surgical materials and the like. When used in absorbent articles, the cellulose acetate can be in any form including, for example, woven or non-woven fibers, fiber tows and the like. In some embodiments, the cellulose acetate can be in flake or powder form when incorporated into an absorbent article.

In other non-limiting embodiments, the cellulose acetate can comprise a seed coating or a coating on a pharmaceutical. In such embodiments, the cellulose acetate can protect the seed or pharmaceutical before gradually being biodegraded during use. During the period that the cellulose acetate coating is intact, the seed or pharmaceutical can be shielded from its surrounding environmental conditions.

In still other various embodiments, the cellulose acetate can be used as an additive in a paint or in a cleansing composition (e.g., a detergent composition or a soap composition). In such embodiments, the cellulose acetate can comprise a stabilizing film composition that enhances the properties of the paint or detergent composition. In yet other various embodiments, the cellulose acetate can be used in hair styling products and various cosmetic products.

In some embodiments, the cellulose acetate can be used as a thickening agent. In some embodiments, the cellulose acetate can be used to increase the viscosity of various foodstuffs or to increase the viscosity of fluids used in subterranean and environmental operations (e.g., drilling fluids, subterranean treatment fluids and the like).

In still other embodiments, the cellulose acetate can be used in cigarette filters or as filler materials in soils.

In still other embodiments, fibers, fiber tows and flake materials comprising cellulose acetate prepared by the present methods are described.

In still other embodiments, cellulose acetate prepared by the present methods can be used in optical materials. The present cellulose acetate can be particularly well suited for this purpose due to its higher optical clarity than is typically obtained in the art.

To facilitate a better understanding of the present invention, the following examples of preferred embodiments are given. In no way should the following examples be read to limit, or to define, the scope of the invention.

### EXAMPLES

Gel permeation chromatography (GPC) analyses for molecular weight determinations were conducted on a Shimadzu Prominence HPLC system using THF mobile phase at 40° C. with an evaporative light scattering detector using a column set of Phenomenex Phenogel columns measuring 300 mm×7.8 mm and having 10³ Å, 10⁴ Å and 10⁵ Å pore size columns in series.

### Example 1

### Synthesis of Cellulose Acetate Using Portionwise Addition of a Sulfuric Acid Catalyst at 14% Catalyst Loading

Method A (Comparative): A control synthesis of cellulose acetate was conducted by combining cellulose, acetic anhydride and a single portion of concentrated sulfuric acid (14% by weight relative to cellulose) and allowing a reaction to occur. Method B: Synthesis of cellulose acetate by portionwise addition of the sulfuric acid catalyst was conducted by combining cellulose, acetic anhydride and concentrated sulfuric acid (13% by weight relative to cellulose) and allowing a reaction to occur. Once the peak reaction temperature had been reached, an additional portion of sulfuric acid (1% by weight relative to cellulose) was added, and the reaction was allowed to proceed.

For both methods, the total catalyst loading, reagent amounts and peak reaction temperature were approximately the same. For Method A, the time until partial neutralization was 63 minutes compared to 58 minutes for Method B where portionwise catalyst addition was used. This represents an 8% reduction in batch processing time. Partial neutralization to produce cellulose diacetate was conducted identically under standard conditions for both methods after adding magnesium acetate and water to stop the reaction. For Method B, approximately 643 grams of wet pulp (˜8% moisture) was combined with 238 g of acetic acid, prior to combining a mixture of 1871 g of acetic acid, 1560 g of acetic anhydride and 82.6 g of sulfuric acid with reaction mixture. At the peak exotherm temperature, the remaining 6.0 grams of sulfuric acid diluted in acetic acid was added to the reaction mixture. Table 1 presents comparative data for the cellulose acetate product made by Methods A and B. As demonstrated in Table 1, the cellulose acetate made using portionwise addition of the catalyst had properties that were comparable to slightly superior to those made using a single addition of catalyst.

TABLE 1
Comparison of Cellulose Acetate Produced from
a Single Addition of Catalyst (Method A) and
Portionwise Addition of Catalyst (Method B)

| | Mois- | | Intrinsic | 6% Vis- | | | Solu- |
|---|---|---|---|---|---|---|---|
| | ture | | Vis- | cosity | Filter- | Particle | tion |
| | Content | AV | cosity | (cps) | ability | Count | Clarity |
| METH- | 2.86 | 55.96 | 1.7697 | 106 | 30 | 7911 | 15.03 |
| OD A | | | | | | | |
| (n = 5) | | | | | | | |
| METH- | 3.01 | 56.26 | 1.8496 | 162 | 43 | 7775 | 12.96 |
| OD B | | | | | | | |
| (n = 5) | | | | | | | |

### Example 2

### Synthesis of Cellulose Acetate Using Low Levels of a Sulfuric Acid Catalyst or a Mixed Sulfuric Acid/Phosphoric Acid Catalyst

Cellulose acetate was synthesized in a manner similar to that described in Example 1, except that the total catalyst loading was lowered to about 0.6% by weight of the cellulose. When a mixed sulfuric acid/phosphoric catalyst was used, the concentration ratio was 1:1. In each reaction, approximately 20 g of wet pulp (˜7% moisture) was used, and the wet pulp was initially mixed with acetic acid prior to combining with a mixture of acetic acid, acetic anhydride and catalyst. The second portion of catalyst was added approximately 20 minutes after the maximum exotherm had been reached. Sampling was conducted at 10 minute intervals after the reaction was judged to be complete by visual inspection. Tables 2 and 3 summarize the molecular weight of the cellulose acetate product obtained at various stages of the reaction.

TABLE 2
Average Molecular Weight of Cellulose Acetate Synthesized by
Portionwise Addition of a Sulfuric Acid/Phosphoric Acid Catalyst

| Cellulose Source | Sample ID | Mₙ | M_{w} | M_{z} |
|---|---|---|---|---|
| Acros Commercial | — | 172,000 | 309,000 | 499,000 |
| Cellulose Triacetate | | | | |
| Acetate Grade | Reaction 1, 1st Pull | 236,000 | 416,000 | 664,000 |
| Hardwood Pulp | Reaction 1, 2nd Pull | 193,000 | 332,000 | 532,000 |
| | Reaction 1, 3rd Pull | 187,000 | 354,000 | 587,000 |
| | Reaction 2, 1st Pull | 199,000 | 356,000 | 577,000 |
| | Reaction 2, 2nd pull | 172,000 | 309,000 | 505,000 |
| Paper Grade | 1st Pull | 203,000 | 401,000 | 673,000 |
| Hardwood Pulp | 2nd Pull | 224,000 | 379,000 | 587,000 |
| | 3rd Pull | 223,000 | 383,000 | 600,000 |
| | 4th Pull | 204,000 | 353,000 | 559,000 |

TABLE 3
Average Molecular Weight of Cellulose Acetate
Synthesized by Portionwise Addition of a Sulfuric Acid
Catalyst or a Sulfuric Acid/Phosphoric Acid Catalyst

| Cellulose Source | Catalyst | Sample ID | Mₙ | M_{w} |
|---|---|---|---|---|
| Acros Organics | — | — | 172,000 | 309,000 |
| Cellulose Triacetate | | | | |
| Acetate Grade | H₃PO₄/H₂SO₄ | 1st Pull | 133,000 | 285,000 |
| Hardwood Pulp | H₃PO₄/H₂SO₄ | 2nd Pull | 127,000 | 250,000 |
| | H₃PO₄/H₂SO₄ | 3rd Pull | 121,000 | 227,000 |
| | H₃PO₄/H₂SO₄ | 4th Pull | 116,000 | 218,000 |
| Acetate Grade | H₂SO₄ | 1st Pull | 164,000 | 332,000 |
| Hardwood Pulp | H₂SO₄ | 2nd Pull | 148,000 | 294,000 |
| | H₂SO₄ | 3rd Pull | 130,000 | 261,000 |
| | H₂SO₄ | 4th Pull | 131,000 | 267,000 |

In Tables 2 and 3, (Mₙ) is the number average molecular weight, (M_{w}) is the weight average molecular weight, (M_{z}) is the Z average molecular weight. It is to be noted that the data for the cellulose acetate prepared using a mixed sulfuric acid/phosphoric acid catalyst is for different batches, which accounts for the differing molecular weights presented.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is the following:

1. A method comprising:
preparing a reaction mixture comprising an acylating agent and cellulose;
instilling a catalyst comprising an acid to the reaction mixture at an overall catalyst loading level of about 1% or less by weight of the cellulose; and
reacting the cellulose with the acylating agent in the presence of the catalyst, thereby forming an acylated cellulose.

2. The method of claim 1, wherein the catalyst comprises sulfuric acid and, optionally, phosphoric acid.

3. The method of claim 1, wherein the acylating agent comprises at least acetic anhydride and the acylated cellulose comprises acetylated cellulose.

4. The method of claim 1, wherein the catalyst is instilled portionwise to the reaction mixture while reacting takes place.

5. The method of claim 1, wherein the catalyst is instilled continuously to the reaction mixture while reacting takes place.

6. The method of claim 1, wherein at least some of the catalyst is instilled to the reaction mixture after a maximum exotherm of the reaction has been reached.

7. The method of claim 6, wherein up to about 5% of the catalyst is instilled to the reaction mixture after the maximum exotherm of the reaction has been reached.

8. A method comprising:
preparing a reaction mixture comprising acetic anhydride, cellulose and a first portion of a catalyst comprising at least sulfuric acid;
instilling at least a second portion of the catalyst to the reaction mixture at an overall catalyst loading level of about 1% or less by weight of the cellulose; and
reacting the cellulose with the acetic anhydride in the presence of the catalyst, thereby forming an acetylated cellulose.

9. The method of claim 8, further comprising:
hydrolyzing the acetylated cellulose to remove a portion of the acetyl groups therefrom.

10. The method of claim 8, wherein the acetylated cellulose has improved filterability compared to an acetylated cellulose synthesized when the catalyst is added all at once.

11. The method of claim 8, wherein the second portion of the catalyst is instilled portionwise to the reaction mixture while reacting takes place.

12. The method of claim 8, wherein the second portion of the catalyst is instilled continuously to the reaction mixture while reacting takes place.

13. The method of claim 8, wherein at least some of the second portion of the catalyst is instilled to the reaction mixture after a maximum exotherm of the reaction has been reached.

14. The method of claim 13, wherein up to about 5% of the catalyst is instilled to the reaction mixture after the maximum exotherm of the reaction has been reached.

15. The method of claim 8, wherein the catalyst further comprises phosphoric acid.

16. A method comprising:
preparing a reaction mixture comprising acetic anhydride and cellulose;
instilling a catalyst comprising at least sulfuric acid to the reaction mixture at an overall catalyst loading level of about 1% or less by weight of the cellulose, thereby forming a reaction product that comprises an acetylated cellulose; and
hydrolyzing a portion of the acetyl groups on the acetylated cellulose to produce an acetylated cellulose having a degree of substitution (DS) of about 2.5 or lower.

17. The method of claim 16, further comprising:
neutralizing at least a portion of the sulfuric acid prior to hydrolyzing.

18. The method of claim 16, wherein the cellulose comprises a non-dissolving grade cellulose.

19. The method of claim 16, wherein at least some of the catalyst is instilled to the reaction mixture after a maximum exotherm of the reaction has been reached.

20. The method of claim 19, wherein up to about 5% of the catalyst is instilled to the reaction mixture after the maximum exotherm of the reaction has been reached.

21. The method of claim 16, wherein the catalyst further comprises phosphoric acid.
